(19) United States
(12) Patent Application Publication
(10) Pub. No.: US 2013/0124969 A1
(43) Pub. Date: May 16, 2013

(54) XML EDITOR WITHIN A WYSIWYG APPLICATION

(71) Applicants: Richard Earl Schochler, Keller, TX (US); Eric Eugene Lawson, Allen, TX (US); Roumel Ignacio Bobadilla, Richardson, TX (US); Donald Thomas Smith, Grand Prairie, TX (US)

(72) Inventors: Richard Earl Schochler, Keller, TX (US); Eric Eugene Lawson, Allen, TX (US); Roumel Ignacio Bobadilla, Richardson, TX (US); Donald Thomas Smith, Grand Prairie, TX (US)

(73) Assignee: Crowell Solutions, Inc., Dallas, TX (US)

(21) Appl. No.: 13/295,739

(22) Filed: Nov. 14, 2011

(51) Int. Cl. G06F 17/00; G06F 9/44

(52) U.S. Cl. 715/234; 717/136

(57) ABSTRACT

A WYSIWYG (what you see is what you get) application that is originally incapable of rendering an XML (Extensible Markup Language) file is converted into a WYSIWYG editor capable of rendering the XML file and manipulating the XML file in a WYSIWYG manner. Upon conversion, the WYSIWYG editor is capable of loading, saving, editing and/or outputting the XML file in a WYSIWYG manner as if the XML file were originally supported by the WYSIWYG application.

### BACKGROUND

In the current era of information, the volume of information has increased explosively. This information explosion not only poses a challenge in data storage, but also introduces problems of how to effectively structure information and how to effectively create structured information.

To provide a solution, XML (Extensible Markup Language), which is a markup language for documents that include structured information, has been developed. XML provides a technology for developing data structures that facilitate description, storage, and communication of information. The structured information may include content such as text, pictures, etc., and use indicators or tags to describe each piece of the content.

A number of software environments for developing XML content have thus far been developed. However, these software environments separate editing from publishing and require a separate rendering engine to render the developed XML content for publishing and thus fail to provide immediate rendering results to content creators who manipulate the XML content. Therefore, the content creators cannot visually examine how the developed XML content will actually appear when rendered (e.g., when printed on paper) until the XML content is rendered by the separate rendering engine in a process completely separate from an editing session. This poses difficulties to the content creators who then need to imagine how the rendered XML content will look as they edit the content. This approach also unnecessarily increases the amount of time and cost for developing the XML content if, for example, the content creators later find that rendered results of their XML content fail to meet requirements and hence need to repeat the development cycle for subsequent modification of the XML content or modify the separate rendering environment.

### SUMMARY

This summary introduces simplified concepts of a WYSIWYG (what you see is what you get) application for XML content, which is further described below in the Detailed Description. This summary is not intended to identify essential features of the claimed subject matter, nor is it intended for use in limiting the scope of the claimed subject matter.

This application describes example embodiments of a WYSIWYG application for XML content. In one embodiment, a WYSIWYG (what you see is what you get) application, such as Microsoft Word®, that is originally incapable of rendering an XML (Extensible Markup Language) file is converted into a WYSIWYG XML editor capable of rendering the XML file and manipulating the XML file in a WYSIWYG manner. In one embodiment, upon conversion, the WYSIWYG editor is capable of loading, saving, editing and/or outputting the XML file in a WYSIWYG manner as if the XML file were originally supported by the WYSIWYG application.

In some embodiments, an application receives a request to render an XML source file. In response to receiving the request, the application renders the XML source file without using an XSL (Extensible Stylesheet Language) formatting object or converting content of the XML source file into the XSL formatting object.

In some embodiments, a full-featured XML editor is built within a WYSIWYG application. The WYSIWYG application is originally incapable of rendering and/or manipulating an XML file. The full-featured XML editor within the WYSIWYG application transforms the WYSIWYG application into a full-featured WYSIWYG XML application that is able to render and manipulate the XML file in a way that provides a same editing experience of the native WYSIWYG application.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment including an XML editor transformation system.

FIG. 2 illustrates the example XML editor transformation system of FIG. 1 in more detail.

FIG. 3 illustrates a screenshot of a user interface for designing a template for translating or interpreting content and/or structure of an XML file under a specific XML schema.

FIG. 4 illustrates a screenshot of rendered content of an example XML file displayed in a user interface of an application.

FIG. 5 illustrates a screenshot of manipulating rendered content of an example XML file in a user interface of an application.

FIG. 6 illustrates an example method of transforming a WYSIWYG application that is originally incapable of rendering and/or manipulating an XML file into a WYSIWYG editor that is capable of rendering and/or manipulating the XML file in a WYSIWYG manner.

FIG. 7 illustrates an example method of rendering and/or manipulating content of an XML file using an application that is originally incapable of rendering and/or manipulating the content of the XML file.

### DETAILED DESCRIPTION

### Overview

As noted above, existing XML environments fail to provide a user-friendly environment for creating XML content, and require content creators to possess sophisticated skills in order to develop the XML content effectively. Further, the additional procedure of rendering the XML content at an end stage of a development cycle is prone to undesired errors in the developed XML content and thus unnecessarily increases the time for developing the XML content if the undesired errors are only observed at a later stage of the development cycle. This is especially true when a novice content creator, rather than an experienced content creator, develops the XML content. Furthermore, this additional procedure increases business costs fof implementing XML that can be avoided using a true WYSIWYG XML editor.

This disclosure describes an XML editor transformation system, which transforms an application that is originally incapable of rendering and/or manipulating an XML file into an XML editor that is capable of rendering and/or manipulating the XML file in a WYSIWYG (what you see is what you get) manner.

Generally, the XML editor transformation system enables an application that is originally incapable of or has no original functionality/intention of rendering and/or manipulating XML content to render and/or manipulate the XML content in a WYSIWYG manner. Rendering and/or manipulating the XML content in a WYSIWYG manner may include, but is not limited to, loading, saving, editing and/or outputting the XML file in the WYSIWYG manner. Outputting the XML file may include, for example, printing the content of the XML file in a same appearance as what is seen or appeared in a user interface of the application. Additionally or alternatively, outputting the XML file may include generating another file format such as a PDF (portable document format) file in which layout of the content is the same as what is seen or appeared in the user interface of the application. Specifically, what you see (i.e., layout and format, for example, of rendered content displayed at a user interface of an application) is what you get (layout and format, for example, of content printed and/or generated in a file format).

In one embodiment, the application may include, but is not limited to, a word or text processing application such as Microsoft Word®, OpenOffice.org Writer®, iWork®, etc., or a browser application such as Internet Explorer®, FireFox®, Netscape®, Google Chrome®, Safari®, etc. Additionally or alternatively, the application may include any WYSIWYG application (or a non-WYSIWYG application) that is originally incapable of or has no original functionality of rendering and/or manipulating XML content in a WYSIWYG manner.

In one embodiment, the XML editor transformation system may enable the application to render and/or manipulate the XML content in a WYSIWYG manner, for example, by installing part or all of the XML editor transformation system in the application. In one embodiment, the XML editor transformation system may enable the application (e.g., WYSIWYG application) to render and/or manipulate the XML content in a WYSIWYG manner as if the XML content was content that the application is originally able or configured to render and/or manipulate in a WYSIWYG manner. In some embodiments, the XML editor transformation system may enable the application (e.g., a non-WYSIWYG application) to render and/or manipulate the XML content in a WYSIWYG manner by extending functionalities of the application to allow rendering and/or manipulation of the XML content in a WYSIWYG manner.

In one embodiment, the XML editor transformation system may act as an XML-related or XML-specific system within the application. When the application receives a request to render (e.g., open) an XML-related file, the application may detect that the file is an XML-related file based on, for example, a file extension of the file, a data structure of the file, etc. In response to detecting the file to be an XML-related file, the application may transfer the XML-related file to the XML editor transformation system for rendering.

In some embodiments, the XML editor transformation system may render the XML-related file on behalf of the application and display content of the XML-related file through a user interface of the application. Additionally or alternatively, the XML editor transformation system may act as a translator between the XML-related file and the application. By way of example and not limitation, the XML editor transformation system may translate the structure and/or the content of the XML-related file into a form or format that is recognizable by the application and allow the application to render the content of the XML-related file based on the recognizable form or format.

In one embodiment, the XML editor transformation system may include one or more rules to conform the XML-related file which is originally unable to be rendered and/or manipulated by the application into a form or format that can be recognized by the application for rendering and/or manipulation. Additionally or alternatively, the XML editor transformation system may create a rule file or a template file including the one or more rules that are used to perform the above conformation. The XML editor transformation system and/or the application may maintain, access and/or use the rule file to render and/or manipulate the XML-related file.

In one embodiment, the XML editor transformation system may render and/or manipulate the XML-related file without using an XSL (Extensible Stylesheet Langauge) formatting object (XSL-FO) or without converting structure or content of the XML-related file into one or more XSL formatting objects. XSL-FO is a markup language for XML document formatting which enables paginated formatting of XML content. For example, XSL-FO is most often used for generating a PDF (portable document format) file from an XML document or file. Additionally or alternatively, the XML editor transformation system may render and/or manipulate the XML-related file without using any other formatting language that is foreign or external to the application and/or the XML editor transformation system.

In some embodiments, the XML editor transformation system may validate the structure and/or content of the XML-related file based on an XML schema. The XML editor transformation system may validate the structure and/or content of the XML-related file in response to loading the XML-related file but before, during or after rendering the structure and/or content of the XML-related file onto a user interface of the application. Additionally or alternatively, the XML editor transformation system may validate the structure and/or content of the XML-related file as a user of the application edits the structure and/or content of the XML-related file through the application. Additionally or alternatively, the XML editor transformation system may validate the structure and/or content of the XML-related file prior to saving or outputting the structure and/or content of the XML-related file through the application.

The described system transforms an application that is originally incapable of or has no original functionality of rendering and/or manipulating an XML-related file into a WYSIWYG application capable of rendering and/or manipulating the XML-related file in a WYSIWYG manner.

While in the examples described herein, the XML editor transformation system may operate as a plug-in or another application program with respect to the application that is originally incapable of rendering and/or manipulating an XML file, in other embodiments, the XML editor transformation system may be a standalone full-featured WYSIWYG application for rendering and/or manipulating an XML file (or structure and/or content of an XML file) in a WYSIWYG manner.

Furthermore, functions described herein to be performed by the XML editor transformation system may be performed by multiple separate systems or services. For example, in one embodiment, a rendering service may render or enable the application to render the structure and/or the content of the XML file while a validation service may validate the structure and/or the content of the XML file against an XML schema, and yet another service may allow manipulation of the structure and/or the content of the XML file in the application as if the XML file was originally supported by the application.

Moreover, although the XML editor transformation system is described herein as a plug-in or an application program partially or completely built within an application that is originally incapable of rendering and/or manipulating an XML file, in some embodiments, the XML editor transformation system may be a process or an application program that is run in an operating system, for example. Therefore, rather than providing support to a specific application which is incapable of rendering and/or manipulating an XML file for rendering and/or manipulating the XML file, the XML editor transformation system may act as a universal platform providing a plurality of methods or services to a plurality of applications (such as a word processing application, a browser application, etc.) that are incapable of rendering and/or manipulating an XML file to call upon for rendering and/or manipulating the XML file.

The application describes multiple and varied implementations and embodiments. The following section describes an example environment that is suitable for practicing various implementations. Next, the application describes example systems, devices, and processes for implementing an XML editor transformation system.

### Exemplary Environment

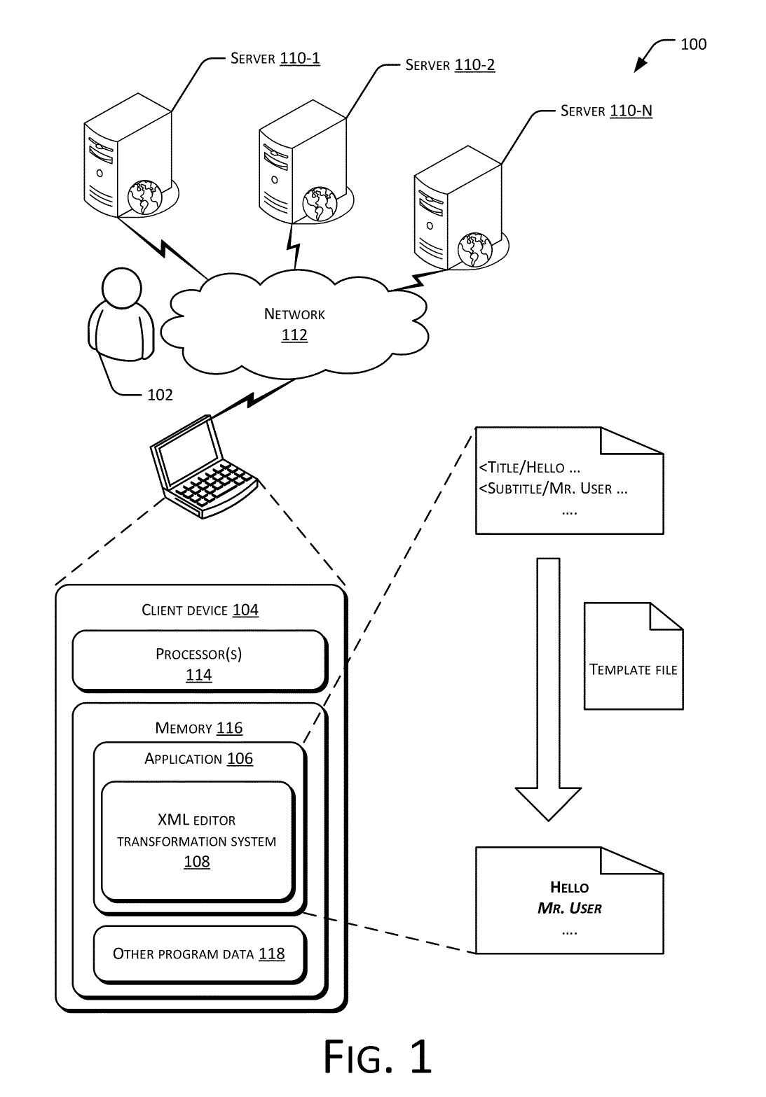

FIG. 1 illustrates an exemplary environment 100 usable to implement an XML editor transformation system. The environment 100 includes a user 102, a client device 104 including an application 106, and an XML editor transformation system 108. In one embodiment, part or all of the XML editor transformation system 108 may be included in the client device 104 or the application 106. For example, the XML editor transformation system 108 may act as a plug-in or add-on to the application 106. In some embodiments, the XML editor transformation system 108 may be included in one or more servers 110-1, 110-2, . . . , 110-N (which are collectively referred to as 110) and communicate data with the application 106 through a network 112, for example.

The client device 104 may be implemented as any of a variety of conventional computing devices including, for example, a server, a desktop PC (personal computer), a notebook or portable computer, a workstation, a mainframe computer, a handheld device, a netbook, an Internet appliance, a portable reading device, an electronic book reader device, a tablet or slate computer, a game console, a mobile device (e.g., a mobile phone, a personal digital assistant, a smart phone, etc.), a media player, etc. or a combination thereof.

The network 112 may be a wireless or a wired network, or a combination thereof. The network 112 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof. In one embodiment, the network 112 may include a near field communication channel. Examples of a near field communication channel include, but are not limited to, infrared communication, radio-frequency identification (RFID), Bluetooth®, WiFi®, WiFi® connect, ZigBee®, infrared data association (IrDA), high-frequency modulated visible light and/or modulated audio.

In one embodiment, the client device 104 includes a processor 114 coupled to memory 116. The memory 116 includes the applications 106 (e.g., a word processing application, a browser application, etc.) and other program data 118. The memory 116 may be coupled to, associated with, and/or accessible to other devices, such as network servers, routers, and/or other client devices 104.

The user 102 may want to view and/or edit an XML file. The user 102 may be an experienced XML developer, a novice XML developer, or any other person who may or may not be familiar with XML language. The user 102 may want to view and/or edit content of the XML file in a WYSIWYG manner using the application 106, for example. Specifically, the user 102 may want to view and edit the content of the XML file in a rendered form in a WYSIWYG manner, and be able to output (i.e., print, publish, or generate a PDF file) the content of the XML file from the application 106. The application 106 may be an application originally incapable or having no original intention of rendering and/or manipulating the content of the XML file.

In one embodiment, the XML editor transformation system 108 enables the application 106 (which is originally incapable of rendering and/or manipulating the content of the XML file in a WYSIWYG manner) to perform these WYSIWYG operations (e.g., loading, editing, saving, outputting, etc.) related to the content of the XML file for the user 102. The user 102 may manipulate (for example, load, edit, print, etc.) the content of the XML file in a same way as the user 102 would normally do for content of a file that is originally supported by the application 106.

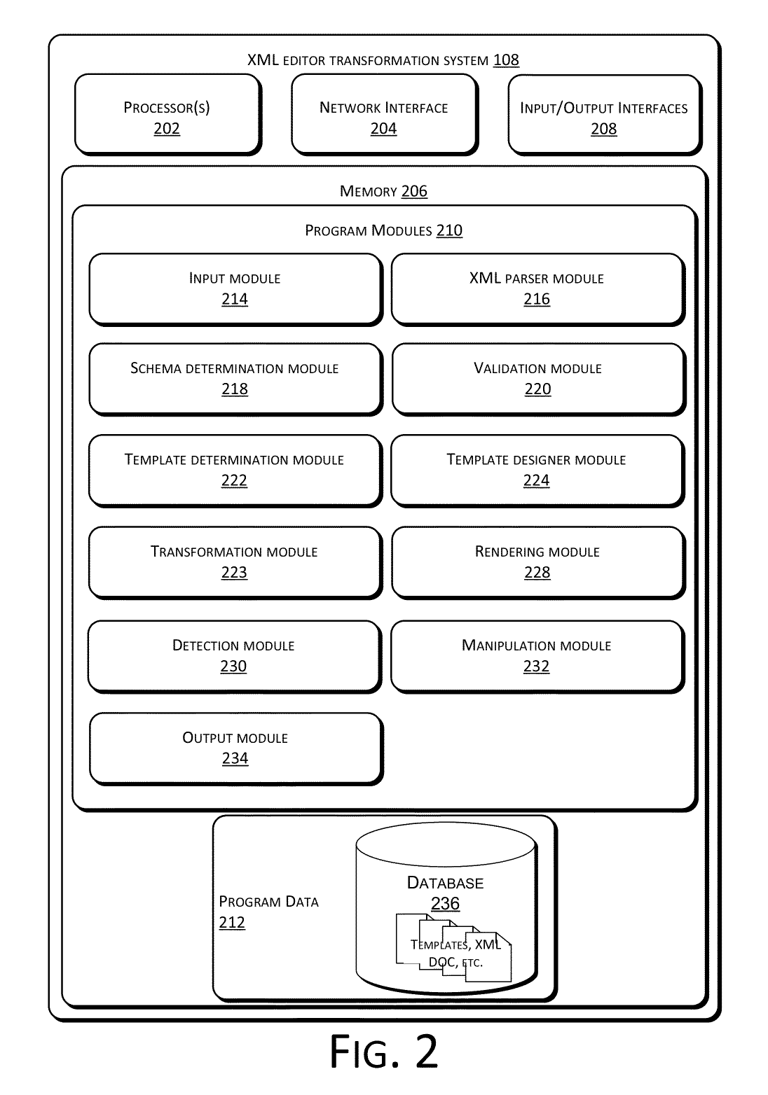

FIG. 2 illustrates the XML editor transformation system 108 in more detail. In one embodiment, the system 108 can include, but is not limited to, one or more processors 202, a network interface 204, memory 206, and an input/output interface 208. The processor 202 is configured to execute instructions received from the network interface 204, received from the input/output interface 208, and stored in the memory 206.

The memory 206 may include computer-readable media in the form of volatile memory, such as Random Access Memory (RAM) and/or non-volatile memory, such as read only memory (ROM) or flash RAM. The memory 206 is an example of computer-readable media. Computer-readable media includes volatile and non-volatile, removable and non-removable media implemented in any method or technology for storage of information such as computer readable instructions, data structures, program modules, or other data. Computer-readable media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer readable media does not include transitory media such as modulated data signals and carrier waves.

The memory 206 may include program modules 210 and program data 212. In one embodiment, the XML editor transformation system 104 may include an input module 214. The input module 214 may act as an interface between the XML editor transformation system 104 and the application 106 to receive requests or inputs from the application 106. Additionally or alternatively, the input module 214 may intercept inputs or requests from the user 102 that are submitted to the application 106 through one or more input means (e.g., a keyboard, a pointing device, etc.) associated with the client device 104.

By way of example and not limitation, the user 102 may want to load content of a file from the application 106. The application 106 may determine that the file is an XML file (e.g., an XML source file) based on, for example, a file extension of the file, a data structure of the file, etc. The application 106 may transfer the determined XML file (or a filehandle of the determined XML file) to the input module 214 for the XML editor transformation system 104 for loading content of the XML file. Alternatively, the application 106 may read the content of the XML file and forward the read content of the XML file to the input module 214 of the XML editor transformation system 104.

Additionally or alternatively, the user 102 may want to edit, save or output content of an open XML file. The application 106 may transfer the content of the open XML file to the input module 214 for the XML editor transformation system 108 to perform respective operations for the application 106.

In response to receiving a request or input from the user 102 or the application 106, the input module 214 may determine a type of the request or input and transfer the request or input to a respective module of the XML editor transformation system 108 based on the determined type.

In one embodiment, in response to determining that the type of the request or input is an XML file or unparsed content of an XML file, the input module 214 may transfer the XML file or the unparsed content of the XML file to an XML parser module 216 for parsing. In response to receiving the XML file or the content of the XML file, the XML parser module 216 may open the XML file and/or parse the content of the XML file. In one embodiment, the XML parser module 216 may parse the content of the XML file to obtain a DOM (Document Object Model) document. In some embodiments, the XML parser module 216 may parse the content of the XML file into a specific format or object that is recognized by the XML editor transformation system 106.

In one embodiment, upon parsing the content of the XML file, the XML editor transformation system 106 may further include a schema determination module 218 that determines an XML schema associated with the XML file. The schema determination module 218 may determine an XML schema from the XML file, for example. The schema determination module 218 may find the XML schema (or respective schema file) based on location information provided in the XML file. In response to finding the XML schema file, the schema determination module 218 may load and read content of the XML schema file. Additionally or alternatively, the schema determination module 218 may load and read the content of the XML schema file through one or more functionalities provided by the application 106.

Upon obtaining the XML schema, the XML editor transformation system 108 may validate the content and/or structure of the XML file against the obtained XML schema. In one embodiment, the XML editor transformation system 108 may include a validation module 220 to validate the content and/or structure of the XML file based on the obtained XML schema. In one embodiment, if the validation module 220 successfully validates the content and/or structure of the XML file, the validation module 220 may transfer the content of the XML file to a formatting module 222. If the validation module 220, however, fails to validate the content and/or structure of the XML file, the validation module 220 may send an alert or warning to the application 106 for failed validation. The application 106 may then display an alert or warning of a failed validation to the user 102 on a user interface of the application 106 or a separate window from the application 106.

In some embodiments, the XML editor transformation system 108 may further include a template determination module 222 to determine a template for the XML file. The template may include, for example, one or more rules that facilitate translation or interpretation of the content and/or structure of the XML file into a format or form that is recognizable by the application 106. In one embodiment, the template determination module 222 may determine a template based on the determined XML schema file. By way of example and not limitation, the determined XML schema file may include metadata or information indicating which template(s) that an XML file can use. Additionally or alternatively, the template determination module 222 may determine a template for the XML file from the content of the XML file. For example, the content of the XML file may include a template or a file path of a template which the XML editor transformation system 108 may use to translate the content and/or structure of the XML file into a format or form that can be recognized or supported by the application 106.

In some embodiments, the XML editor transformation system 108 may include a template designer module 224 for the user 102 or other user to create a template for use in interpreting the content and/or structure of the XML file, for example. In one embodiment, the template designer module 224 may make use of existing format or rule setting functionalities provided by the application 106 to facilitate creation of a template by the user 102. In one embodiment, the template designer module 224 may make use of existing functionalities of the application 106 that help the user 102 to set up templates, styles, formats, rules, etc., to allow the user 102 to create a template under a user-familiar environment.

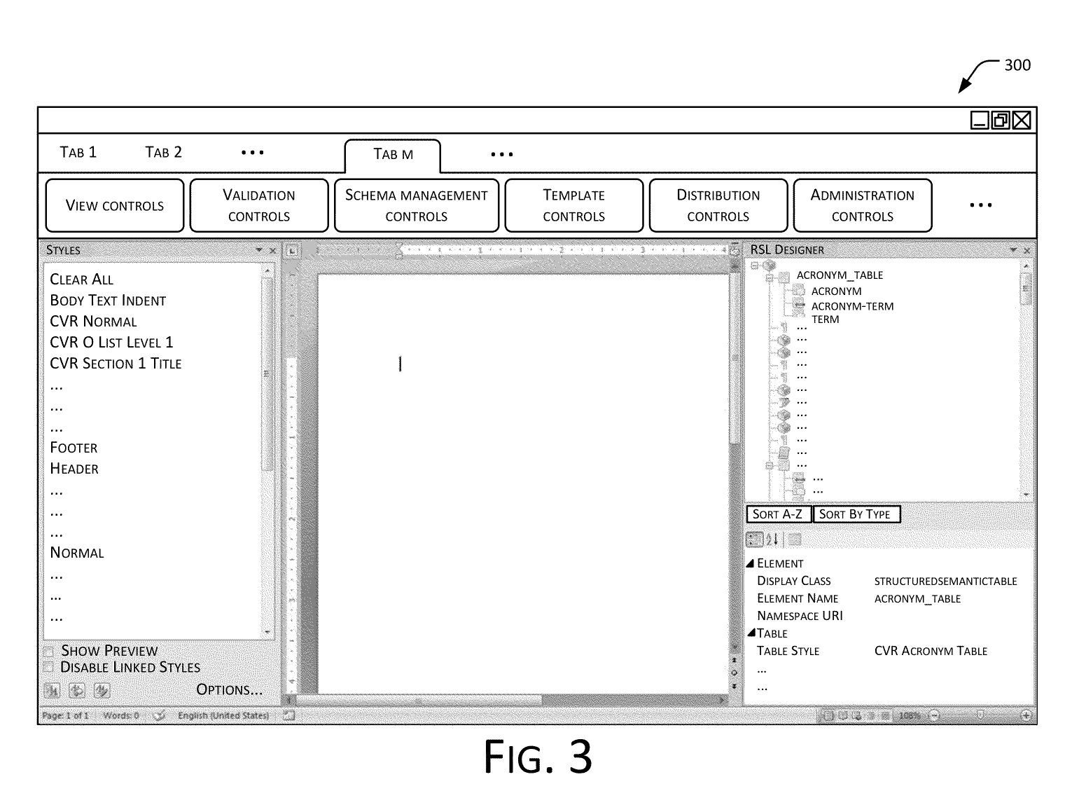

For example, FIG. 3 shows a screenshot illustrating a user interface 300 for designing a template for translating or interpreting content and/or structure of an XML file under a specific XML schema. The template designer module 224 may populate, for example, one or more existing templates, styles, formats (or formatting expressions), rules, etc., that are provided by or native to the application 106 on the user interface shown in FIG. 3, and allow the user 102 to select and create desired formats or forms for respective parts of content and/or structure of an XML file. Examples of templates, styles, formats and rules may include, for example, a heading style, a font style, a tabular format, a page format, a graphical format, etc. In this way, users who are familiar with functions of the application 106 (e.g., Microsoft Word®) will immediately be familiar with using such functions to create templates, styles, formats, rules, etc., in an XML document/file.

Additionally or alternatively, the template designer module 224 may provide one or more new templates, styles, formats, rules, etc., that may not be originally included or provided by the application 106. The template designer module 224 may provide these one or more new templates, styles, formats, rules, etc., to the user 102 in addition or alternative to the existing templates, styles, formats, rules, etc., that are provided by the application 106. These new templates, styles, formats and rules, for example, are templates, styles, formats and rules that can be recognized or supported by the application 106.

Additionally or alternatively, the template designer module 224 may allow the user 102 and/or the application 106 to create or import additional templates, styles, formats, rules, etc., from other applications of the device 104 or applications or devices through the network 112. The template designer module 224 may adapt these imported templates, styles, formats, rules, etc., to the application 106 and provide these imported templates, styles, formats, rules, etc., for the user 102 to select for respective parts of content and/or structure of an XML file, for example.

In response to determining a template for the XML file, the XML editor transformation system 108 may further include a transformation module 226. The transformation module 226 may translate the content and/or structure of the XML file into a format or form that is recognizable by the application 106. In one embodiment, the transformation module 226 may translate or interpret the content and/or structure of the XML file based on the determined template. In some embodiments, the transformation module 226 may translate or interpret the content and/or structure of the XML file based further on the determined XML schema associated with the XML file.

Upon translating or interpreting the content and/or structure of the XML file by the transformation module 226, in one embodiment, the XML editor transformation system 108 may optionally include a rendering module 228 to render the content and/or structure of the XML file onto the user interface of the application 106. In one embodiment, the rendering module 228 may perform this rendering of the content and/or structure of the XML file using one or more functionalities of the application 106. For example, the application 106 may include a rendering engine for rendering content of a file that is originally supported by the application 106. The rendering module 228 may call the one or more functionalities of the application 106 to render the content and/or structure of the XML file on behalf thereof.

Additionally or alternatively, in some embodiments, in response to translating or interpreting the content and/or structure of the XML file by the transformation module 226, the transformation module 226 may transfer the transformed content of the XML file (and possibly information of the translated format or rule that is recognizable by the application 106) to the application 106 for rendering in the user interface of the application 106. Upon transferring the transformed content (and possibly information of the translated format or rule that is recognizable by the application 106), the XML editor transformation system 106 may be free or independent from any operation of rendering the content and/or structure of the XML file onto the user interface of the application 106.

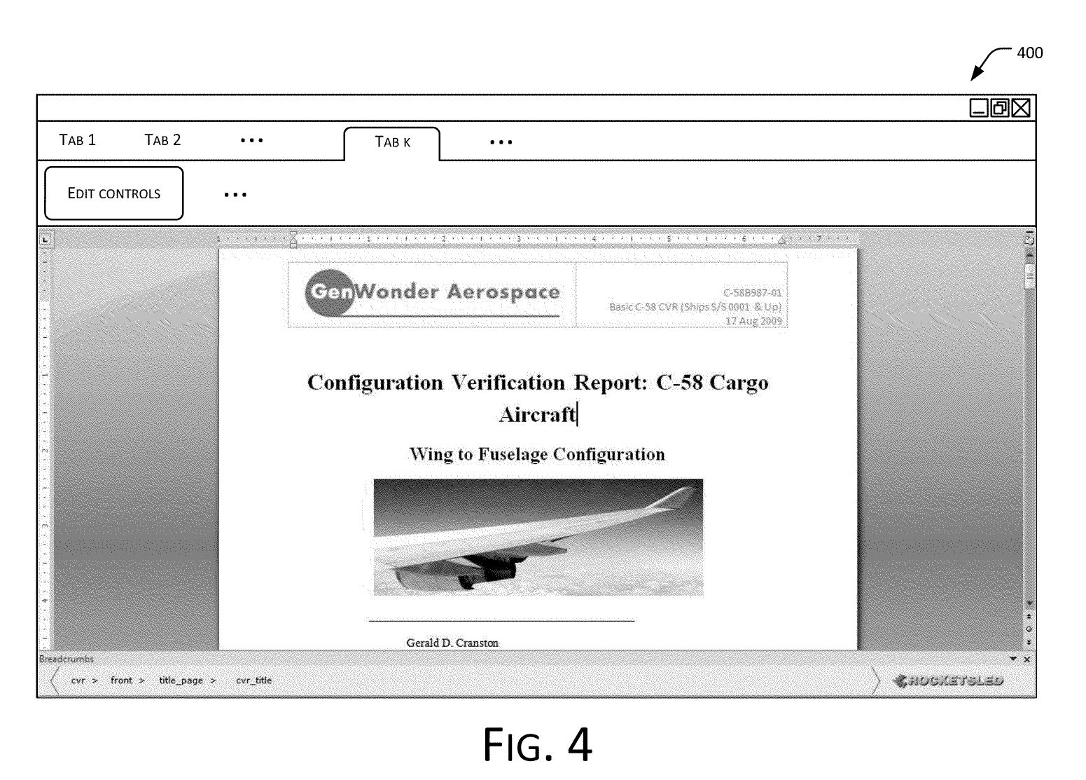

FIG. 4 shows a screenshot illustrating rendered content of an example XML file in a user interface 400 of the application 106. Microsoft Word® is used as an example of the application 106 which is originally incapable of rendering and/or manipulating the XML file for illustrative purpose in this example screenshot. As shown in FIG. 4, content and structure (or page layout) of the XML file is rendered by the application 106 (or the rendering module 228) as if the XML file was a file format originally supported by the application 106 (i.e., Microsoft Word® in this example). The user 102 may then view and/or manipulate (such as edit, save, print, etc.) the rendered content of the XML file through the application 106.

In one embodiment, the application 106, without any help from the XML editor transformation system 108, may allow the user 102 to print the rendered content and/or generate a file format of the rendered content (e.g., a PDF format, a document format, a text format, etc.) directly from the application 106 in a WYSIWYG manner. By way of example and not limitation, the user 102 may print the rendered content and/or generate a file format of the rendered content using existing or original functionalities (e.g., print, generate) provided by the application 106. The application 106 allows page layout and format, for example, of content printed and/or generated to be the same as what the user 102 saw when the rendered content appeared in the user interface of the application 106. Specifically, what you see (i.e., layout and format, for example, of the rendered content displayed at the user interface of the application 106) is what you get (layout and format, for example, of content printed and/or generated in a file format).

Additionally or alternatively, the application 106 may allow the user 102 to perform one or more WYSIWYG operations on the rendered content with the help of the XML editor transformation system 106. For example, the application 106 may use the validation module 220 to validate the content displayed on the user interface of the application 106 prior to printing and/or generating a file format of the displayed content if the displayed content has been modified by the user 102 since being loaded into the application 106, for example.

In some embodiments, upon successfully loading the rendered content of the XML file onto the user interface of the application 106, the user 102 may manipulate the rendered content of the XML file. For example, the user 102 may edit the rendered content of the XML file in the application 106. In one embodiment, the XML editor transformation system 108 may optionally include a detection module 230 to detect an intention or an action of the user 102 related to the rendered content of the XML file. By way of example and not limitation, the detection module 230 may detect an input event or a wandering event of the user 102 with respect to the rendered content of the XML file or the application 106. By way of example and not limitation, the detection module 230 may detect that a cursor controlled by the user 102 hovers over a part of the rendered content of the XML file. Additionally or alternatively, the detection module 230 may detect that the user 102 clicks on a part of the rendered content of the XML file or a specific area of the user interface of the application 106 through a pointing device such as a mouse, a stylus, a finger of the user 102, etc. The specific area of the user interface of the application 106 may include, but is not limited to, a button or an icon provided by the application 106 or the XML editor transformation system 108 for manipulating the rendered content, a bar such as an information bar in the user interface of the application 106, etc.

In response to detecting the input event or the wandering event of the user 102, the detection module 230 may send the detected input event or the detected wandering event to a manipulation module 232 of the XML editor transformation system 108. The detection module 230 may provide information such as a location of the detected event to the manipulation module 232.

Additionally or alternatively, the XML editor transformation system 108 may rely on the application 106 to perform such detection of input event and/or wandering event of the user 102. In one embodiment, the application 106 may detect an input event or a wandering event of the user 102 using existing functionalities as the application 106 normally performs for content or files originally supported by the application 106. In response to detecting an input event or a wandering event, the application may actively or passively send information (such as location information) of the detected event to the manipulation module 232.

In response to receiving the information of the detected event from the detection module 230 or the application 106, the manipulation module 232 may determine related information and/or action(s) associated with a part of the rendered content in which the user 102 is interested. In one embodiment, the manipulation module 232 may determine information (such as name, attributes, etc.) of an element (or tag) to which the interested part of the rendered content belongs. The manipulation module 232 may determine this information of the element to which the interested part of the rendered content belongs based on, for example, information of the associated XML schema.

Additionally or alternatively, the manipulation module 232 may determine an existing format or form (or allowable format(s) or form(s)) of the interested part of the rendered content. The manipulation module 232 may determine the existing format or form (or the allowable format(s) or form(s)) of the interested part of the rendered content based on, for example, the template associated with the XML file.

Additionally or alternatively, the manipulation module 232 may determine one or more allowable actions on the interested part of the rendered content. By way of example and not limitation, the manipulation module 232 may determine one or more allowable actions on the interested part of the rendered content based on the associated XML schema, the associated template and/or actions (or functions) provided by the application 106.

In response to determining related information and/or action(s) associated with the interested part of the rendered content, the manipulation module 232 may return the determined information and/or action(s) to the rendering module 228 or the application 106, depending on which is responsible for rendering the content of the XML file. In one embodiment, the rendering module 228 or the application 106 may display one or more indicators, hints, dialogs, etc., to the user 102, providing information or selectable options of a subset (or all) of the determined information and/or action(s) to the user 102. By way of example and not limitation, the rendering module 228 or the application 106 may display a dialog indicating allowable formats or forms for the interested part of the rendered content as specified by the associated schema.

Additionally or alternatively, the rendering module 228 or the application 106 may display a node tree indicating an element (or node) to which the interested part of the rendered content belongs. The node tree may correspond to the XML schema associated with the XML file that is being rendered. The user 102 may be allowed to select or click a node of the displayed node tree. In response to receiving a user selection of a node on the displayed node tree, the rendering module 228 or the application 106 may display further information (such as allowable format, attributes of the selected node, etc.) related to the selected node to the user 102.

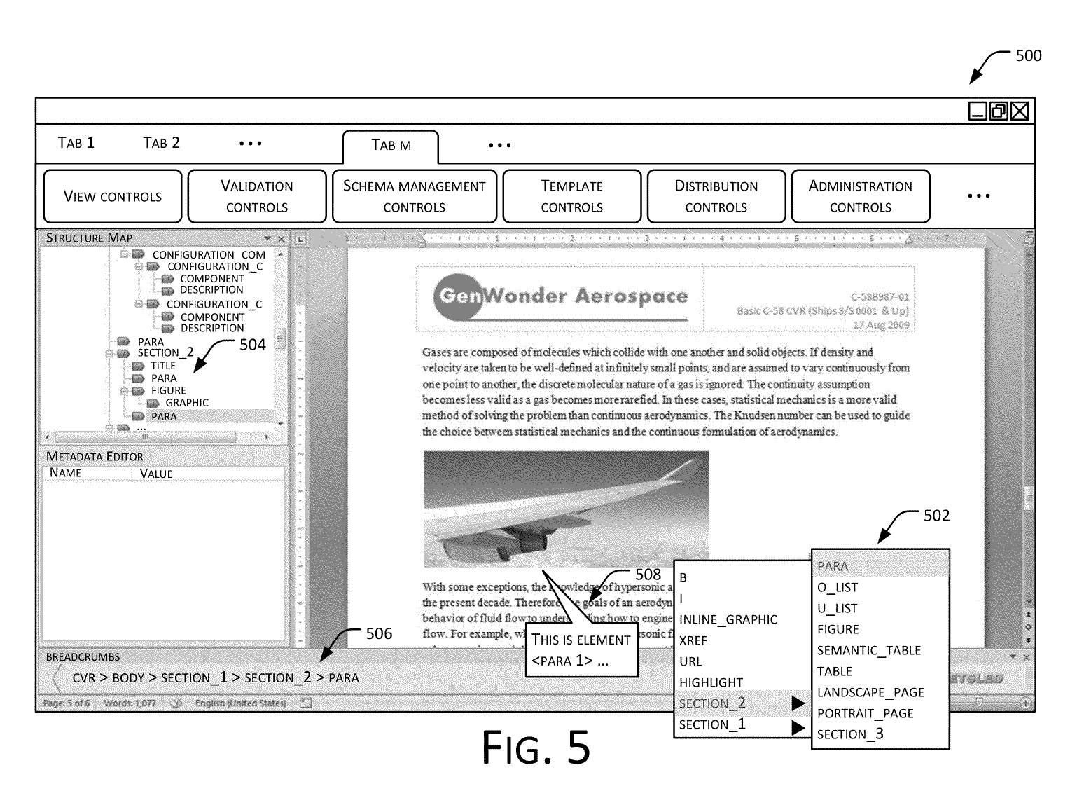

Additionally or alternatively, the rendering module 228 or the application 106 may display the information or selectable options of the subset (or all) of the determined information and/or action(s) to the user 102 through an information bar (e.g., at the bottom of the user interface, etc.) of the application 106 or a callout. FIG. 5 shows an example scenario 500 illustrating various ways of displaying the information, including, for example, a dialog 502, a node tree 504, an information bar 506 and a callout 508, etc., to the user 102.

Upon displaying the information or selectable options of the subset (or all) of the determined information and/or action(s) to the user 102, the detection module 230 (or the application 106) may wait for a new input event or wandering event from the user 102. For example, the user 102 may want to manipulate (add, modify or delete, etc.) a certain part of the rendered content. In one embodiment, the user 102 may select one of the selectable options to start manipulating the rendered content. Alternatively, the user 102 may directly manipulate (e.g., modify) data of the rendered content. The rendering module 228 or the application 106 may automatically select an action (for example, a format or a form, etc.) for the data manipulated by the user 102.

In one embodiment, in response to detecting the new input event such as modifying the data of the rendered content by the user 102, the validation module 220 may validate the modified data against the associated XML schema. Additionally or alternatively, the formatting module 222 may format the modified data based on the template associated with the XML file and allow content (including modified data, for example) of the XML file to be rendered by the rendering module 228 or the application 106 in a WYSIWYG manner.

In some embodiments, the user 102 may want to print the rendered XML content from the application 106. Additionally or alternatively, the user 102 may want to generate a file format (e.g., a PDF file) for the content that is rendered at the application 106. The user 102 may perform these operations (i.e., printing, generating a file format, etc.) using methods as described in the foregoing embodiments.

In one embodiment, the user 102 may want to save the XML content that is rendered in the user interface of the application 106. In one embodiment, the user 102 may save the XML content that is rendered in the user interface of the application 106 using an existing or original functionality provided by the application 106, e.g., a “save” button. In response to receiving a request from the user 102 to save the XML content rendered in the user interface of the application 106, the application 106 may save the rendered XML content in an XML format.

In one embodiment, the user 102 may want to export the XML content that is rendered in the user interface of the application 106. In one embodiment, the user 102 may export the XML content that is rendered in the user interface of the application 106 using an existing or original functionality provided by the application 106, e.g., an “export” button. In response to receiving a request from the user 102 to save the XML content rendered in the user interface of the application 106, the application 106 may export the rendered XML content in a native file format of the WYSIWYM application such as a Word Doc format if Microsoft Word® is used as the WYSIWYG application, for example.

In one embodiment, the application 106 may actively or passively send a save request to an output module 234 of the XML editor transformation system 106 that helps to transform the rendered XML content into content in an XML format (i.e., including tag, metadata, etc.). The output module 234 may perform this transformation using a template opposite to the template used for converting the XML content and/or structure into a format or form that is recognizable by the application 106. Upon transforming the rendered XML content (that is displayed in the user interface of the application 106) into content in an XML format, the output module 234 may save the content in the XML format as an XML file. Alternatively, the output module 234 may return the content in the XML format to the application 106 which may then save the XML format using existing or original save functionality of the application 106.

Although the foregoing embodiments describe the XML editor transformation system 108 and/or the application 106 render or display content of an XML file in the user interface of the application 106 at the front end according to the format and/or layout described in an associated template, the XML editor transformation system 108 and/or the application 106 may further keep track and/or maintain metadata associated with the XML file at the back end. By way of example and not limitation, the XML editor transformation system 108 and/or the application 106 may keep track and/or maintain information of respective elements and hierarchical structures of the elements as the rendered content is loaded, modified, outputted and/or saved.

In one embodiment, the XML editor transformation system 108 and/or the application 106 may maintain mirror XML content corresponding to the rendered content displayed in the user interface of the application 106. The XML editor transformation system 108 and/or the application 106 may update the mirror XML content as the rendered content displayed in the user interface of the application 106 changes. In one embodiment, the mirror XML content may be in a plain XML format including data, tags, metadata, etc. Alternatively, the mirror XML content may include tags, metadata, placeholders for respective rendered content displayed in the application 106, etc., with or without including actual data corresponding to the rendered content.

Furthermore, depending on which operation the user 102 wants to perform for the rendered content, the XML editor transformation system 108 or the application 106 may use the rendered content displayed in the user interface of the application 106 or the mirror XML content directly. For example, the XML editor transformation system 108 or the application 106 may directly use the rendered content displayed in the user interface of the application 106 for printing and/or generating a file format of the rendered content. The XML editor transformation system 108 or the application 106 may alternatively use the mirror content for a save operation, for example. This may therefore facilitate the XML editor transformation system 108 or the application 106 later to save the rendered XML content back into an XML source format, for example.

In some embodiments, the XML editor transformation system 108 may further include a database 236 that is configured to store templates, styles, formats, rules, forms, etc., that have been created and imported in the application 106 and/or the XML editor transformation system 108, and/or originally provided by the application 106. For example, the user 102 may obtain the determined template described in the foregoing embodiments from this database 236. The database 236 allows the user 102 to select existing templates, styles, formats, rules, forms, etc., of the application 106 and/or the XML editor transformation system 108, and therefore facilitates the user 102 to develop a suitable template, a style, a format, a rule, a form, etc., for an XML file (e.g., an XML source file/document) by, for example, selecting, reusing and/or modifying an existing template, style, format, rule, form, etc., to fit a particular specification associated with the XML file.

### Exemplary Methods

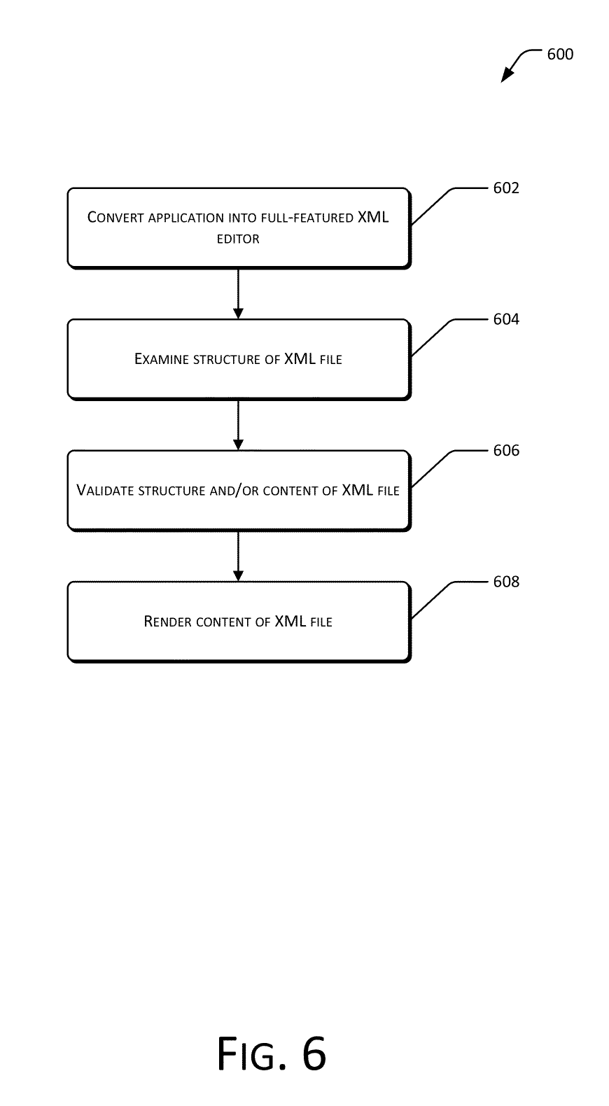

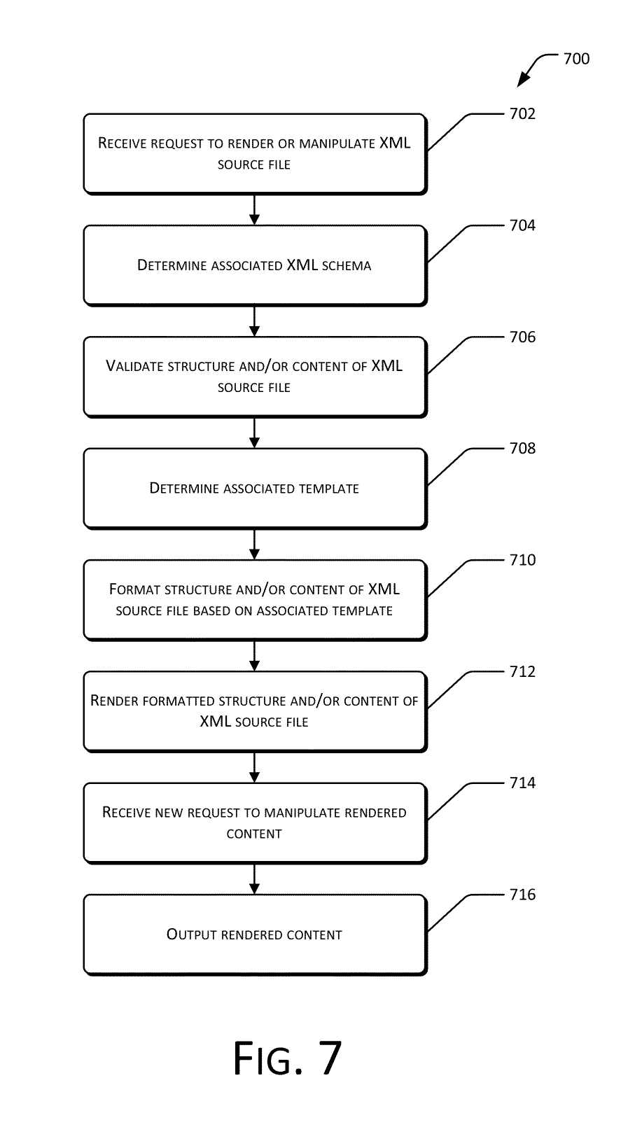

FIG. 6 is a flow chart depicting an example method 600 of transforming a WYSIWYG application that is incapable of rendering an XML file into a WYSIWYG editor that is capable of rendering and/or manipulating the XML file in a WYSIWYG manner. FIG. 7 illustrates an example method of rendering and/or manipulating content of an XML file using an application that is originally incapable of rendering and/or manipulating the content of the XML file. The methods of FIG. 6 and FIG. 7 may, but need not, be implemented in the environment of FIG. 1 and using the system of FIG. 2. For ease of explanation, methods 600 and 700 are described with reference to FIGS. 1 and 2. However, the methods 600 and 700 may alternatively be implemented in other environments and/or using other systems.

Methods 600 and 700 are described in the general context of computer-executable instructions. Generally, computer-executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network. In a distributed computing environment, computer-executable instructions may be located in local and/or remote computer storage media, including memory storage devices.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations.

Referring back to FIG. 6, at block 602, the XML editor transformation system 108 converts a WYSIWYG application (e.g., the application 106) that is originally incapable of rendering and/or manipulating an XML file into a WYSIWYG editor that is capable of rendering and/or manipulating the XML in a WYSIWYG manner. As described before, the application 106 may include, but is not limited to, a text processing/editor application, a browser application, etc. Rendering and/or manipulating the XML file in a WYSIWYG manner may include, but is not limited to, loading, saving, editing and/or outputting content of the XML file in a WYSIWYG manner.

In one embodiment, the XML editor transformation system 108 may act as, for example, a full-featured XML editor that is built within the application 106. By way of example but not limitation, the XML editor transformation system 108 may act as a plug-in or an add-on to the application 106. In some embodiments, the XML editor transformation system 108 may act as a universal platform providing a plurality of methods or services to a plurality of applications (including the application 106) that are incapable of rendering and/or manipulating an XML file to call upon for rendering and/or manipulating the XML file.

By building the XML editor transformation system 108 in the application 106, the XML editor transformation system 108 transforms the application 106 into a full-featured WYSIWYG application for rendering and/or manipulating the XML file. In some embodiments, the XML editor transformation system 108 (or the full-featured XML editor) may enable the application 106 to render and/or manipulate the XML file in a same way as a file that is originally supported by the application 106.

At block 604, the XML editor transformation system 108 may perform the above conversion by, for example, examining a structure of the XML file based on a template that includes one or more rules. In one embodiment, the one or more rules are configured to convert the structure of the XML file into a format or rule that is recognizable by the application 106. The XML editor transformation system 108 may therefore interpret the structure of the XML file into a format or a rule that is recognizable by the application 106, for example, based on the one or more rules in the template.

At block 606, the XML editor transformation system 108 may validate the structure and/or content of the XML file based on an XML schema. In one embodiment, the XML editor transformation system 108 may validate the structure and/or the content of the XML file prior to interpreting the structure of the XML into the format or rule recognizable by the application 106. Alternatively, the XML editor transformation system 108 may validate and interpret the structure and/or the content of the XML file substantially concurrently.

At block 608, the XML editor transformation system 108 or application 106 may render the content of the XML file based on the recognizable format or rule.

Referring to FIG. 7, at block 702, the application 106 (which is originally incapable of rendering and/or manipulating content of an XML source file) receives a request to render or manipulate an XML source file.

At block 704, in response to receiving the request, the XML editor transformation system 108 may determine an XML schema associated with the XML source file.

At block 706, in response to determining an XML schema that is associated with the XML source file, the XML editor transformation system 108 may validate structure and/or content of the XML source file based on the determined XML schema.

At block 708, before, during or after validating the XML source file, the XML editor transformation system 108 may determine a template that includes one or more rules for formatting the structure and/or content of the XML source file.

At block 710, upon determining the template, the XML editor transformation system 108 may format the structure and/or content of the XML source file based on the one or more rules in the template. In one embodiment, the XML editor transformation system 108 may format the structure and/or content of the XML source file into one or more formats that are recognizable by the application 106 based on the one or more rules in the template. In some embodiments, the XML editor transformation system 108 may format the structure and/or content of the XML source file into one or more new formats that are recognizable but not originally provided by the application 106. For example, the XML editor transformation system 106 may make use of certain formatting rules originally provided by the application 106 to create one or more new formats or rules that are still recognizable by the application 106.

At block 712, the XML editor transformation system 108 or the application 106 may render the formatted structure and/or content of the XML source file in a user interface of the application 106.

At block 714, the application 106 may receive a new request from a user of the application 106 (e.g., the user 102) to manipulate the rendered content of the XML source file. The new request may include, for example, editing, saving or outputting the rendered content of the XML source file.

At block 716, in response to receiving the new request (e.g., outputting the rendered content), the application 106 may output the rendered content of the XML source file as the rendered content appeared in the user interface of the application. In one embodiment, the application 106 may output the rendered content of the XML source file as if were outputting content of a file that was originally supported by the application 106 without the help of the XML editor transformation system 108.

For example, if the new request is to print the rendered content, the application 106 may print the rendered content through a printer communicatively connected therewith. Alternatively, if the new request is to generate another file format such as a PDF file, the application 106 may produce a PDF file having structure and layout of the content in a same way as the content of the XML file that is rendered in the user interface of the application 106. If the new request is to publish the rendered content of the XML source file on another application such as a publishing application or a website, the application 106 may export the rendered content of the XML source file as if were publishing content of a file that was originally supported by the application 106 without the help of the XML editor transformation system 108.

Although the above acts are described to be performed by the XML editor transformation system 108, one or more acts that are performed by the XML editor transformation system 108 may be performed by the application 106 or other software or hardware of the client device 104 and/or any other computing device, and vice versa. For example, the application 106 may determine and read a template that includes one or more rules for formatting structure and/or content of an XML file, and transform the structure and/or content of the XML file into a format or rule that is recognizable by the application 106. Additionally or alternatively, the application 106 may validate the structure and/or content of the XML file using an XML schema.

Any of the acts of any of the methods described herein may be implemented at least partially by a processor or other electronic device based on instructions stored on one or more computer-readable media. By way of example and not limitation, any of the acts of any of the methods described herein may be implemented under control of one or more processors configured with executable instructions that may be stored on one or more computer-readable media such as one or more computer storage media.

### Conclusion

Although the invention has been described in language specific to structural features and/or methodological acts, it is to be understood that the invention is not necessarily limited to the specific features or acts described. Rather, the specific features and acts are disclosed as exemplary forms of implementing the invention.

What is claimed is:

1. A method comprising:
under control of one or more processors configured with executable instructions:
converting a WYSIWYG (what you see is what you get) application originally incapable of rendering an XML (Extensible Markup Language) file into a WYSIWYG editor capable of rendering the XML file and manipulating the XML file in a WYSIWYG manner, wherein the rendering is performed without transforming the XML file into an XSL (Extensible Stylesheet Language) formatting language object, and the converting comprises:
interpreting a structure of the XML file into a format or rule that is recognizable by the WYSIWYG application; and
rendering, by the WYSIWYG application, content of the XML file based on the recognizable format or rule.

2. The method as recited in claim 1, wherein the interpreting comprises:
examining the structure of the XML file based on a template comprising one or more rules configured to convert the structure of the XML file into the format or rule that is recognizable by the WYSIWYG application, the one or more rule in the template being set based on one or more formats or rules provided by the WYSIWYG application;
validating the content of the XML file against an XML schema; and
rendering, by the WYSIWYG application, the content of the XML file based on one or more rules in the template.

3. A method comprising:
under control of one or more processors configured with executable instructions:
converting a WYSIWYG (what you see is what you get) application originally incapable of rendering an XML (Extensible Markup Language) file into a WYSIWYG editor capable of rendering the XML file and manipulating the XML file in a WYSIWYG manner.

4. The method as recited in claim 3, wherein the converting comprises interpreting a structure of the XML file into a format or rule that is recognizable by the WYSIWYG application.

5. The method as recited in claim 4, wherein the converting further comprises rendering, by the WYSIWYG application, content of the XML file based on the recognizable format or rule native to the WYSIWYG editing application.

6. The method as recited in claim 4, wherein the interpreting comprises:
examining the structure of the XML file based on a template comprising one or more rules configured to convert the structure of the XML file into the format or rule that is recognizable by the WYSIWYG application; and
rendering, by the WYSIWYG application, the content of the XML file based on one or more rules in the template.

7. The method as recited in claim 6, wherein the interpreting further comprises setting the one or more rules in the template based on one or more formats or rules provided by the WYSIWYG application.

8. The method as recited in claim 6, wherein the interpreting further comprises validating the content of the XML file against an XML schema.

9. The method as recited in claim 3, wherein the converting is performed without transforming the XML file into a formatting language object foreign to the WYSIWYG editor.

10. The method as recited in claim 9, wherein the formatting language object foreign to the WYSIWYG editor comprises an XSL (Extensible Stylesheet Language) formatting object.

11. The method as recited in claim 3, wherein manipulating the XML file in the WYSIWYG manner comprises loading, saving, editing and/or outputting the XML file in the WYSIWYG manner.

12. The method as recited in claim 3, wherein the WYSIWYG application comprises a text editor application or a browser application.

13. One or more computer-readable media configured with computer-executable instructions that, when executed by one or more processors, configure the one or more processors to perform acts comprising:
receiving, at an application, a request to render an XML (Extensible Markup Language) source file; and
rendering the XML source file without using an XSL (Extensible Stylesheet Language) formatting object.

14. The one or more computer-readable media as recited in claim 13, wherein the acts further comprise:
determining an XML schema associated with the XML source file; and
validating the XML source file based on the XML schema.

15. The one or more computer-readable media as recited in claim 14, wherein the acts further comprise:
determining a template comprising one or more rules for formatting content of the XML source file; and
formatting the content of the XML source file based on the one or more rules in the template.

16. The one or more computer-readable as recited in claim 15, wherein the formatting comprises formatting the content of the XML source file into one or more formats that are recognizable by the application based on the one or more rules in the template.

17. The one or more computer-readable media as recited in claim 15, wherein the acts further comprise rendering the formatted content of the XML source file in a user interface of the application.

18. The one or more computer-readable media as recited in claim 17, wherein the acts further comprise outputting the formatted content of the XML source file as it appeared in the user interface of the application.

19. The one or more computer-readable media as recited in claim 18, wherein the outputting comprises:
printing the formatted content of the XML source file;
publishing the formatted content of the XML source file on a website; and/or
generating a portable document format of the formatted content of the XML source file.

20. The one or more computer-readable media as recited in claim 13, wherein the application comprises a WYSIWYG (what you see is what you get) component incapable of rendering the XML file and another component capable of translating content and structure of the XML file into a format that is recognizable by the WYSIWYG component for rendering the content and structure of the XML file on a user interface of the WYSIWYG component in a WYSIWYG format.

21. The one or more computer-readable media as recited in claim 13, wherein the application comprises a non-WYSIWYG (what you see is what you get) component for the XML file and another component capable of translating content and structure of the XML file into a format that is recognizable by the non-WYSIWYG component for rendering the content and structure of the XML file on a user interface of the non-WYSIWYG component in a WYSIWYG format.

22. A system comprising:
one or more processors;
memory, communicatively coupled to the one or more processors, storing instructions that, when executed by the one or more processors, configure the one or more processors to perform acts comprising:
building a full-featured XML editor within a WYSIWYG (what you see is what you get) application, the WYSIWYG application being originally incapable of rendering and manipulating an XML file, the building comprising transforming the WYSIWYG application into a full-featured WYSIWYG application for rendering and manipulating the XML file.

23. The system as recited in claim 22, wherein the full-featured XML editor enables the WYSIWYG application to render and manipulate the XML file in a same way as a file that is originally supported by the WYSIWYG application.
